(19) United States
(12) Patent Application Publication
(10) Pub. No.: US 2006/0012066 A1
(43) Pub. Date: Jan. 19, 2006

(54) System and method for directing a fluid through a die

(75) Inventors: Herbert L. Hutchison, Blacklick, OH (US); Jeffrey R. Brandt, Blacklick, OH (US); Matthew F. Kollar, Powell, OH (US)

Correspondence Address: STANDLEY LAW GROUP LLP, 495 METRO PLACE SOUTH, SUITE 210, DUBLIN, OH, 43017, US

(73) Assignee: Crane Plastics Company LLC, Columbus, OH (US)

(21) Appl. No.: 11/023,988

(22) Filed: Dec. 27, 2004

Related U.S. Application Data
(63) Continuation-in-part of application No. 10/430,979, filed on May 7, 2003, now abandoned.
Application No. 10/430,979 is a continuation-in-part of application No. 10/280,735, filed on Oct. 25, 2002.
Application No. 10/280,735 is a continuation-in-part of application No. 10/131,578, filed on Apr. 24, 2002, now Pat. No. 6,637,213.
Application No. 10/131,578 is a continuation-in-part of application No. 10/025,432, filed on Dec. 19, 2001, now Pat. No. 6,708,504.
Application No. 10/025,432 is a continuation-in-part of application No. 09/766,054, filed on Jan. 19, 2001, now Pat. No. 6,578,368.

(51) Int. Cl. B29C 47/76

(52) U.S. Cl. 264/102

(57) ABSTRACT

A system and method for directing a fluid through a die. A transfer device for a fluid (e.g., a cooling fluid or a material) may extend through an interior of the die. The transfer device may be situated such that undesired heat transfer with other portions of the die is limited.

This is a continuation-in-part of U.S. application Ser. No. 10/430,979, filed May 7, 2003, pending, which is a continuation-in-part of U.S. application Ser. No. 10/280,735, filed Oct. 25, 2002, pending, which is a continuation-in-part of U.S. application Ser. No. 10/131,578, filed Apr. 24, 2002, now U.S. Pat. No. 6,637,213, which is a continuation-in-part of U.S. application Ser. No. 10/025,432, filed Dec. 19, 2001, now U.S. Pat. No. 6,708,504, which is a continuation-in-part of U.S. application Ser. No. 09/766,054, filed Jan. 19, 2001, now U.S. Pat. No. 6,578,368, each of which is hereby incorporated by reference in its entirety.

### BACKGROUND AND SUMMARY OF THE INVENTION

The present invention relates generally to a system and method for directing a fluid through a die. One embodiment of the present invention is a system and method for cooling extruded and molded materials with a fluid that is below about 80 degrees Fahrenheit. Another embodiment of the present invention is a system and method for directing a fluid through a die, such as for cooling a product or forming a layer or portion of a product.

For several reasons, there is a need to find materials that exhibit the look and feel of natural wood. The supply of wood in the world's forests for construction and other purposes is dwindling. Consequently, the supply of wood from mature trees has become a concern in recent years, and the cost of wood has risen. As a result, several attempts have been made by others to find a suitable wood-like material.

Cellulosic/polymer composites have been developed as replacements for all-natural wood, particle board, wafer board, and other similar materials. For example, U.S. Pat. Nos. 3,908,902, 4,091,153, 4,686,251, 4,708,623, 5,002,713, 5,055,247, 5,087,400, 5,151,238, 6,011,091, and 6,103,791 relate to processes and/or compositions for making wood replacement products. As compared to natural woods, cellulosic/polymer composites offer superior resistance to wear and tear. In addition, cellulosic/polymer composites have enhanced resistance to moisture, and it is well known that the retention of moisture is a primary cause of the warping, splintering, and discoloration of natural woods. Moreover, cellulosic/polymer composites may be sawed, sanded, shaped, turned, fastened, and finished in the same manner as natural woods. Therefore, cellulosic/polymer composites are commonly used for applications such as interior and exterior decorative house moldings, picture frames, furniture, porch decks, deck railings, window moldings, window components, door components, roofing structures, building siding, and other suitable indoor and outdoor items. However, many attempts to make products from cellulosic/polymer composite materials have failed due to poor or improper manufacturing techniques.

In one embodiment of the present invention, a product or article may be manufactured by a desired technique such as, but not limited to, extrusion, compression molding, injection molding, or other similar, suitable, or conventional manufacturing techniques. The product is then cooled by subjecting it to a cooling fluid including, but not limited to, direct contact with a liquid cryogenic fluid. The present invention can be used alone or in conjunction with other known or later developed cooling methods. Accordingly, the present invention can more thoroughly and efficiently cool the manufactured product or article to a desired level. This can lead to faster production times as well as a product having improved structural, physical, and aesthetic characteristics.

In addition to cooling extruded or molded materials, the present invention may also be used in other types of manufacturing techniques in which the output or material must be cooled from a heated state. The present invention includes a system and method for cooling synthetic wood composite materials including, but not limited to, cellulosic-filled plastic composites. In addition, the present invention may also be used to cool other types of pure or mixed materials including, but not limited to, plastics, polymers, foamed plastics, plastic compositions, inorganic-filled plastic compositions, metals, metallic compositions, alloys, mixtures including any of the aforementioned materials, and other similar, conventional, or suitable materials that need to be cooled after being processed. For instance, the present invention may be used to cool polyvinyl chloride (PVC) products and products made from other plastics.

The present invention also includes a system and method for directing a fluid through a die. In one embodiment, a fluid may be directed through a die for cooling purposes. In another embodiment, a fluid may be directed through a die for forming a layer or portion of a product. More particularly, a fluid may be directed through a die to form an external or core layer of a product from a foamed or unfoamed material including, but not limited to, a cellulosic-filled plastic composite. For example, the present invention includes a system and method for through the die foaming of extruded products. For instance, a core foam layer may be formed using an exemplary system and method of the present invention. Like the other embodiments of the present invention, this embodiment may be used with other types of pure or mixed materials including, but not limited to, plastics, polymers, foamed plastics, plastic compositions, inorganic-filled plastic compositions, metals, metallic compositions, alloys, mixtures including any of the aforementioned materials, and other similar, conventional, or suitable materials that may be processed through a die. For instance, the present invention may be used to manufacture polyvinyl chloride (PVC) products and products made from other plastics.

In addition to the novel features and advantages mentioned above, other objects and advantages of the present invention will be readily apparent from the following descriptions of the drawings and exemplary embodiments.

### BRIEF DESCRIPTION OF THE DRAWINGS

FIG. 1 is a perspective view of an extrudate.

FIG. 2 is a perspective view of an extrusion die showing an exemplary location of a nozzle.

FIG. 3 is a schematic view of one exemplary embodiment of a system implementing the present invention.

FIG. 4 is a partial cross sectional view along the line A-A of FIG. 3.

FIG. 5 is a partial elevational view of another exemplary embodiment of a system of the present invention.

FIG. 6 shows a sectioned schematic of an extruder line used in accordance with the practice of one exemplary embodiment of the present invention.

FIG. 7 is a cross sectional view from a lateral side angle of an exemplary die of the present invention.

FIG. 8 is a cross sectional view from a top side angle of the die of FIG. 7.

FIG. 9 is a cross sectional view from an exit side angle of the die of FIG. 7.

FIG. 10 is a cross sectional view from a lateral side angle of an exemplary die of the present invention that includes a baffle.

FIG. 11 is a cross sectional view from a lateral side angle of another exemplary die of the present invention that includes a baffle.

FIG. 12 is a schematic view of an exemplary embodiment of a system of the present invention that enables direct cooling by a liquid cryogenic fluid.

FIG. 13 is a side elevational view of an exemplary embodiment of a transfer device of the present invention.

FIG. 14 is a partial view of a die showing exemplary embodiments of a mandrel and a transfer device of the present invention.

### DETAILED DESCRIPTION OF EXEMPLARY EMBODIMENT(S)

The present invention is directed to a system and method for cooling manufactured articles or products. The present invention is also directed to a system and method for directing a fluid through a die. It is not intended to limit the present invention to particular manufacturing techniques or particular materials. The present invention may be used in conjunction with articles or products made by a variety of different manufacturing techniques. Examples of manufacturing techniques that may utilize the present invention include, but are not limited to, extrusion (including co-extrusion), compression molding, injection molding, and other known, similar, or conventional techniques for manufacturing products or articles from plastic, wood, metal, mixtures of these materials, or other materials used to make products.

The present invention is particularly useful with plastics, polymers, and cellulosic/polymer composite materials that have been extruded or molded. The materials that may be used to make cellulosic/polymer composites include, but are not limited to, cellulosic fillers, polymers, plastics, thermoplastics, inorganic fillers, cross-linking agents, lubricants, process aids, stabilizers, accelerators, inhibitors, enhancers, compatibilizers, blowing agents, foaming agents, thermosetting materials, and other similar, suitable, or conventional materials. Examples of cellulosic fillers include sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, bagass, plant fibers, bamboo fiber, palm fiber, kenaf, flax, and other similar materials. In addition to PVC, examples of polymers include multilayer films, high density polyethylene (HDPE), polypropylene (PP), low density polyethylene (LDPE), chlorinated polyvinyl chloride (CPVC), acrylonitrile butadiene styrene (ABS), ethyl-vinyl acetate, other similar copolymers, other similar, suitable, or conventional thermoplastic materials, and formulations that incorporate any of the aforementioned polymers. Examples of inorganic fillers include talc, calcium carbonate, kaolin clay, magnesium oxide, titanium dioxide, silica, mica, barium sulfate, acrylics, and other similar, suitable, or conventional materials. Examples of thermosetting materials include polyurethanes, such as isocyanates, phenolic resins, unsaturated polyesters, epoxy resins, and other similar, suitable, or conventional materials. Combinations of the aforementioned materials are also examples of thermosetting materials. Examples of lubricants include zinc stearate, calcium stearate, esters, amide wax, paraffin wax, ethylene bis-stearamide, and other similar, suitable, or conventional materials. Examples of stabilizers include tin stabilizers, lead and metal soaps such as barium, cadmium, and zinc, and other similar, suitable, or conventional materials. In addition, examples of process aids include acrylic modifiers and other similar, suitable, or conventional materials.

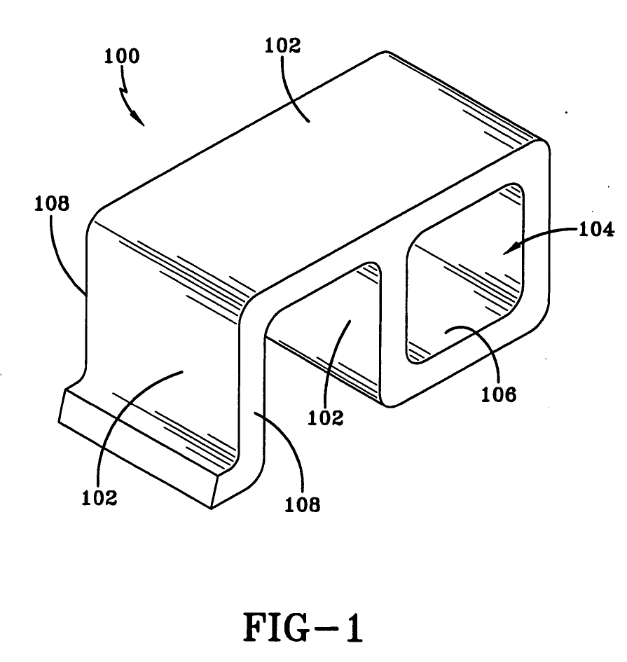

FIG. 1 shows one example of an extrudate 100 that may be cooled by the present invention. The extrudate 100 includes an exterior surface 102, a hollow 104, an interior surface 106, and two ends 108. The exterior surface 102 may be cooled by a traditional method such as using a warm water bath or water mist. However, the interior surface 106 may not be sufficiently cooled by many traditional methods because the surface may not be available for contact with the cooling medium. The interior surface 106 defines the boundary of the hollow 104. It should be recognized that a product may have a plurality of hollows. The interior surface 106 may be accessed from either end 108. The interior surface 106 may not be cooled to a desired level within a desired amount of time by externally applied coolants.

In the present invention, a fluid may be directed into the hollow 104. For example, a fluid may be directed into the hollow 104 for cooling purposes. For another example, a fluid may be directed into the hollow 104 to form another portion or layer of the product 100. For instance, a fluid such as a pure or mixed material may be used to partially or completely fill the hollow 104. Examples of pure or mixed materials include, but are not limited to, plastics, polymers, foamed plastics, plastic compositions, cellulosic-filled plastic compositions, inorganic-filled plastic compositions, metals, metallic compositions, alloys, mixtures including any of the aforementioned materials, and other similar, conventional, or suitable materials. The fluid may be similar or dissimilar to the material used to form the exterior surface 102. For instance, the fluid and the material used to form the exterior surface 102 may consist of the same ingredients, but in different amounts. Alternatively, the fluid and the material used to form the exterior surface 102 may consist of at least one different ingredient. Some examples may be useful to illustrate this point. One example of a product that may benefit from the present invention has a foamed or unfoamed plastic layer that is bonded to another foamed or unfoamed plastic layer. Another example of a product that may benefit from the present invention has a foamed or unfoamed plastic composite layer that is bonded to another foamed or unfoamed plastic composite layer. Still another example of a product that may be benefit from the present invention has a foamed or unfoamed plastic composite layer that is bonded to a foamed or unfoamed plastic layer. Of course, many other embodiments are possible and within the scope of the present invention.

Regardless of the type of fluid, the fluid may be directed into the hollow 104 via an in-line system or a system that is not in-line. In one embodiment, the present invention may be used to provide improved cooling of a product. In another embodiment in which a fluid forms a layer or portion of a product, the present invention may be used to reduce the weight and/or material cost of a product or to improve the physical characteristics of a product. For example, a foamed plastic may be used to form a layer or portion (e.g., a core layer) of a product that would otherwise be entirely formed of an unfoamed plastic. Another possible benefit is that the fluid (such as a fluid that forms a core layer) may help to maintain the integrity of a profile as it is processed through a sizing system. In addition, an in-line system may be more time and cost efficient.

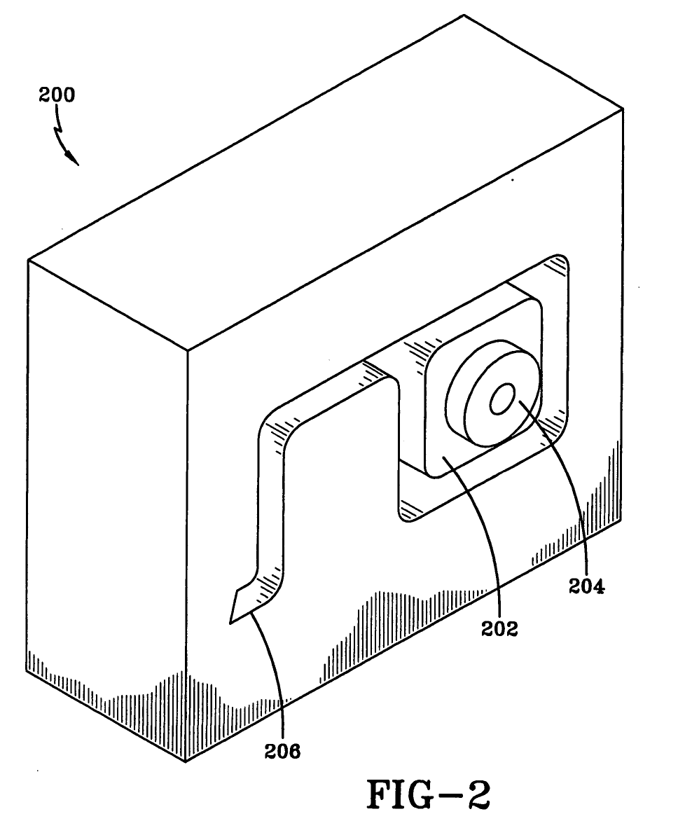

FIG. 2 shows one example of an extrusion die 200 adapted with the present invention. The extrusion die 200 defines the cross section of the extrudate by the shape of the profile form/flow channel 206. Hollows in the cross section of the extrudate may be formed with a standing core 202. The standing core 202 is fitted with a spout or nozzle 204. The nozzle 204 may be adapted to connect with a source of the cooling fluid (not shown). Alternatively, the nozzle 204 may be adapted to connect with a source of a fluid for forming a layer or portion of the resulting product. The nozzle 204 may be oriented to spray or otherwise release the fluid into the hollow formed in the extrudate cross section by the standing core 202. The nozzle 204 may be recessed from, even with, or extend away from the face of the die 200. In an embodiment in which the nozzle 204 extends away from the face of the die 200, the length of the extension may be any desired distance. The extension may also be referred to as a dispensing wand.

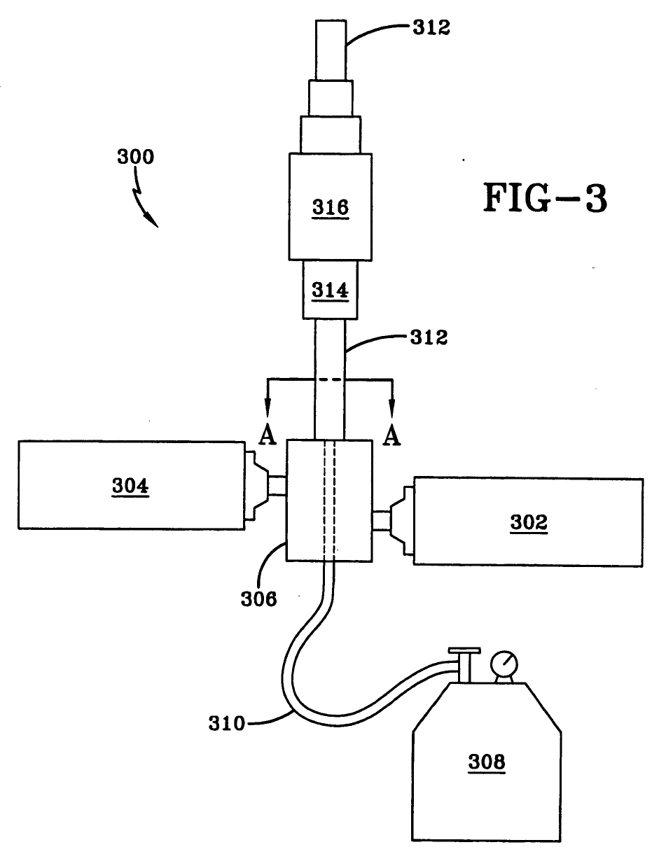

FIG. 3 shows one example of a system 300 that may utilize the present invention. The system 300 includes an extruder 302 and an extruder 304. In this example, a crosshead die 306 puts a cap layer from the extruder 304 on the material extruded by the extruder 302. A container 308 may be used to hold a cooling fluid of the present invention. The fluid is used to cool the extruded product or article 312 after it exits the die 306. In this embodiment, a valve is used to control the release of gas, e.g., vapor, from the fluid. A hose, conduit, tube, or any other suitable transfer device 310 may be used to direct the gas from the container 308 to the desired location for cooling the extruded product 312. The transfer device 310 may be formed by one integral component or a plurality of interconnected components. For instance, a portion of the transfer device 310 may be a passage through the die 306. In this example, the transfer device 310 extends through the die 306 so that the gas is released in the hollow of the extruded product 312 after it exits the die 306. In this manner, the present invention can provide efficient and thorough cooling of the extruded product 312. Moreover, the extruded product 312 may be further introduced into a liquid bath 314, a spray mist chamber 316, and/or any other desired cooling system to achieve additional cooling of the extruded product 312 if desired. Examples of the liquid bath 314 and the spray mist chamber 316 are provided in U.S. Pat. No. 5,827,462.

Depending on the type of cooling fluid and the desired expulsion rate of the cooling fluid, the container 308 may be pressurized. The container 308 may be connected to a compressor, e.g., an air compressor or any other similar, suitable, or conventional compressing device, in order to maintain the desired pressure in the container 308. Additionally, the container 308 may be in fluid communication with a blower or a pump to obtain the desired expulsion rate of the cooling fluid from the container 308. A blower in fluid communication with the container 308 may also be utilized to accelerate the cooling fluid to a desired velocity after it has been expelled.

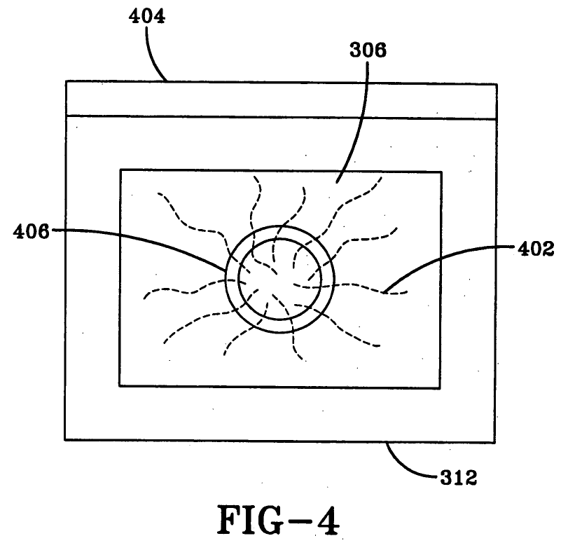

FIG. 4 is a cross section view along the line A-A of FIG. 3. The extruded product 312 includes a cap layer 404. The transfer device 310 may extend through the die 306 to a nozzle 406 that releases gas from the cooling fluid into a hollow of the extruded product 312. In this instance, gas vapor 402 permeates through the hollow of the extruded product 312, thereby providing much improved cooling of the extruded product 312. In fact, the inventors have surprisingly discovered that using the present invention to inject the cooling fluid into a hollow portion of a product may be sufficient to thoroughly cool the entire product, i.e., the inside and the outside of the product. As a result, the present invention may eliminate the need to provide another cooling system to cool the outer surface of the product.

It should be recognized that FIGS. 3 and 4 are merely one example of a manufacturing system that may utilize the present invention. As noted above, the present invention may be used in any manufacturing system in which the processed material needs to be cooled to a desired level. For example, the present invention may be used in an extrusion system consisting of a single extruder that is in-line with a die. Also, the present invention may be used to cool any type of material including, but not limited to, injection molded materials and compression molded materials.

In addition, it should be recognized that the system 300 shown in FIG. 3 may be adapted for use with another fluid that may form a layer or portion of the resulting product. For example, another extruder may be in fluid communication with the die 306 for adding another layer or portion of the resulting product. The extruder may be connected to the die 306 in a manner similar to extruder 302 and extruder 304. If desired, the extruder may be substituted for the container 308 and the transfer device 310. For instance, with reference to FIG. 4, a fluid for forming a core layer (instead of a cooling fluid) may be dispensed from the nozzle 406 into the hollow. However, it should be recognized that this embodiment of the present invention may also be used in combination with the cooling embodiment of the present invention. For example, the fluid may form a layer or portion of the product other than a core layer, or the fluid may not completely fill a hollow portion of the product.

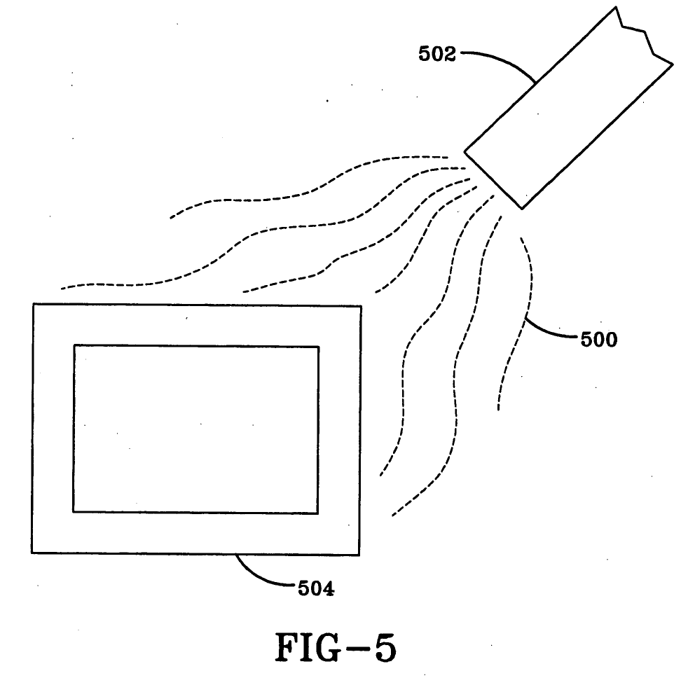

In addition, it should be recognized that the cooling fluid of the present invention may be expelled elsewhere relative to the manufactured product (i.e., other than in a hollow portion of the product). For example, FIG. 5 shows an embodiment in which the gas vapor 500 is dispersed by the transfer device 502 onto the exterior of the product 504. The present invention also includes dispersing multiple streams of the cooling fluid onto the same or different portions of the manufactured product. For instance, flows of the cooling fluid may be simultaneously dispersed onto the exterior and interior surfaces of the manufactured product.

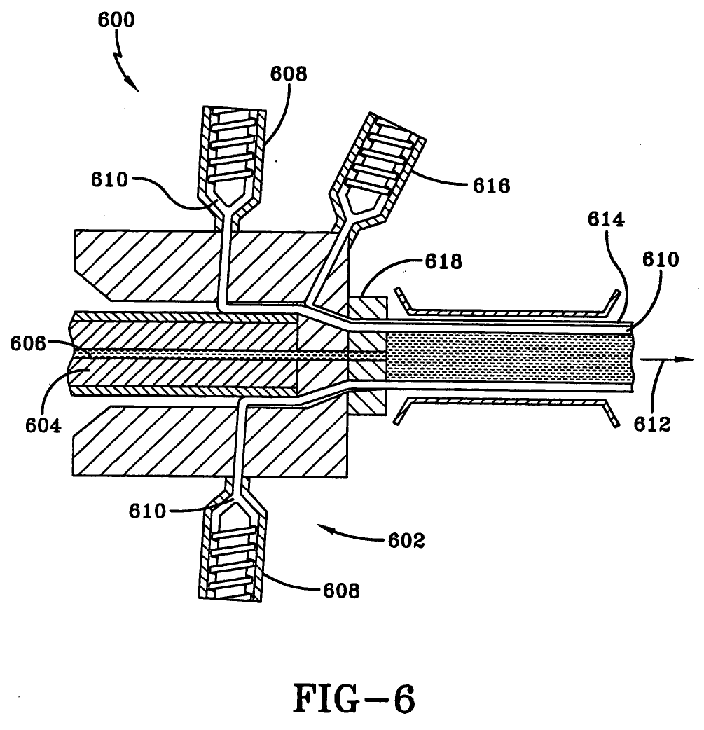

Turning to FIG. 6, this Figure shows a sectioned schematic of an extruder line 600 used in accordance with the practice of one embodiment of the present invention. FIG. 6 shows an extruder line 600 which includes co-extrusion apparatus 602. Co-extrusion apparatus 602 includes insulated transport tube 604 that is adapted to carry cooling fluid 606. Alternatively, the transport tube 604 may be adapted to carry a fluid for forming a layer or portion of the product. The cooling fluid 606 may be gas that may be delivered from a supply of cryogenic fluid. Co-extrusion apparatus 602 also includes a cross head extruder 608 which is adapted to prepare the thermoplastic material 610 for extrusion through a die which may form a hollow, rectangular profile and urges it along longitudinal direction 612. Further layers of thermoplastic material such as layer 614 may be added through the use of additional extruders such as extruder 616. Such additional layers of thermoplastic material may include layers of material with specific characteristics for exterior use, such as fluoropolymers and PVC having greater or lesser durability and resistance to changes in aesthetic appearance resulting from exposure to weather and environmental/atmospheric conditions, as dictated by the desired end user. The thermoplastic material 610 is formed by the forming die 618 into the desired final shape, such as a rectangular cross-section. The cooling fluid 606 permeates through the hollow space created in thermoplastic material 610. The cooling fluid 606 may be at a significantly lower temperature than the surrounding thermoplastic material 610. The cooling fluid 606 cools the thermoplastic material 610, assisting the thermoplastic material to “skin” or solidify.

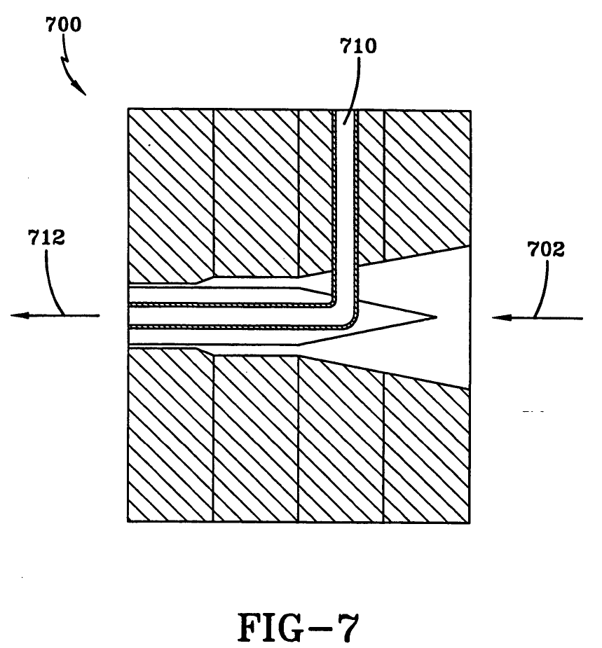

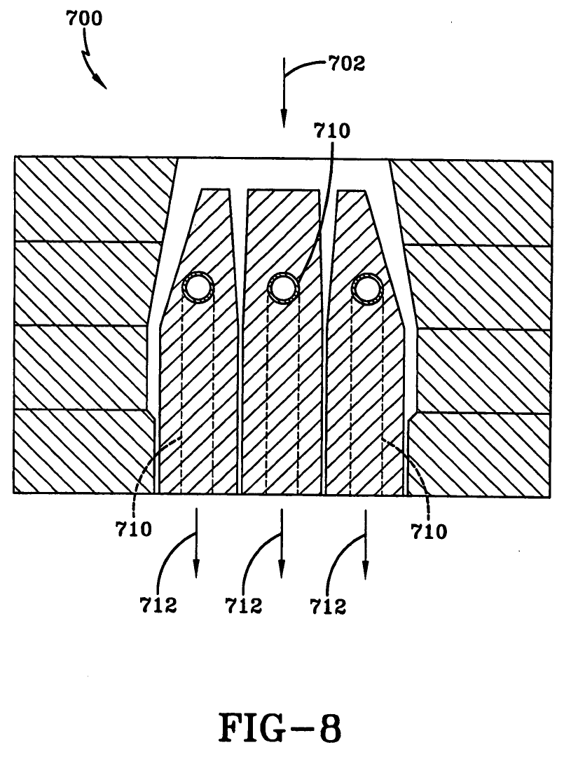

FIGS. 7 through 9 show a cross sectional view of one example of a die 700 that is configured to be in-line with an extruder. Extruded material flows through the die in the direction indicated by arrow 702. In this example, the resultant extrudate 704 defines three hollow portions that are separated by webs 706 and 708. A fluid enters the die 700 through passages 710. The fluid entering through passages 710 may be a cooling fluid or a fluid for partially or completely filling the hollow portions of the extrudate 704. In some embodiments, it should be recognized that a tube, conduit, or any other type of transfer device may extend through the passages 710 for directing the flow of the fluid through the passages 710. The fluid exits the die 700 through passages 710 in the direction indicated by arrows 712. In such an embodiment, the passages 710 intersect the path of flow of the extruded material that forms the extrudate 704. In other words, the passages 710 intersect the flow channel in the die 700.

The die 700 may be heated to a sufficient level to facilitate extrusion and limit premature curing of the extrudate in the die 700. In this example of an in-line system, the passages 710 actually extend through the die 700, intersecting the path of flow of the extruded material that forms extrudate 704. In some embodiments, it may be preferable to limit cooling of the die 700 by a cooling fluid in the passages 710. In other embodiments, a fluid in the passages 710 that is used fill the hollow portions may be processed more effectively at a different temperature (e.g., a higher or lower temperature) than the material used to form the extrudate 704. Accordingly, the passages 710 may be insulated by a suitable material. For example, the passages 710 may be lined with ceramic insulation, putty ceramics, or any other similar, suitable, or conventional insulating material in order to limit undesired heat transfer by the die 700. In fact, it should be recognized that the transfer device for the fluid in any type of embodiment may be insulated in order to limit undesired cooling or heating of surrounding items.

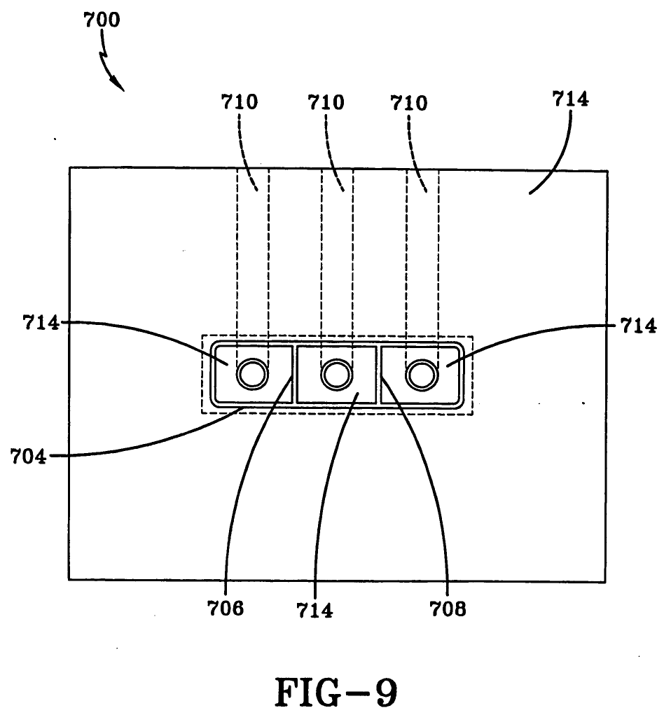

As best seen in the example of FIG. 9, the passages 710 may be substantially surrounded by die material 714 even where the passages 710 intersect the path of flow of the extruded material that forms extrudate 704. In this manner, direct contact in the die 700 between the extruded material that forms extrudate 704 and the passages 710 may be avoided, if desired. The die material 714 surrounding the passages 710 may be heated to facilitate the extrusion process. Also, air gaps may be provided between the die material 714 and the passages 710 for additional insulation.

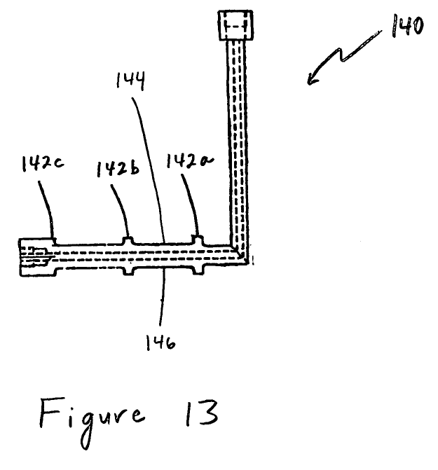

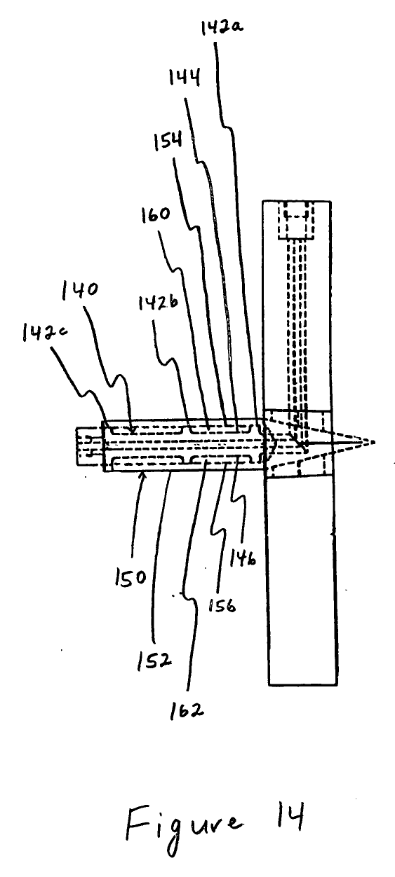

FIGS. 13 and 14 show an example of a transfer device 140 that may be useful for lining a passage and transferring a fluid through the interior of a die. Unless expressly stated otherwise, it is not intended to limit the type of fluid that may be transferred through the transfer device 140. For example, the fluid may be a cooling fluid or a material that forms a product. It is also not intended to limit the transfer device 140 to any particular shape or other dimensions unless expressly stated otherwise. For instance, the transfer device may be a hose, tube, conduit, or any other type of device suitable for transferring a fluid. In addition, the transfer device 140 may have any suitable cross-sectional shape. For example, an exemplary embodiment of the transfer device 140 may be a right circular cylinder, a curved conduit, or any other suitable shape. Furthermore, it is not intended to limit the type of material from which the transfer device 140 may be made unless expressly stated otherwise. As previously indicated, an exemplary embodiment of the transfer device 140 may be comprised of an insulating material (e.g., ceramic material). However, in other embodiments, it should be recognized that the transfer device 140 may be comprised of any of a variety of other suitable materials including, but not limited to, non-insulating materials (e.g., steel).

The transfer device 140 may be adapted to extend through the interior of a die. FIG. 14 is a partial view of an exemplary die assembly in which transfer device 140 is situated in the interior 150 of the die assembly. In particular, the transfer device 140 is situated in a mandrel 152 in the interior 150 of the die assembly. Some other portions of the die assembly are not shown in order to more clearly illustrate the present invention. Such as in the other examples, the transfer device 140 may intersect a flow channel that is adapted to transfer a material through the die.

At least one portion of the transfer device 140 is adapted to be displaced from an interior portion of the die. The resulting separation or gap between the transfer device 140 and the interior portion of the die may be filled by air or another insulating material (e.g., a foam insulating material). As noted earlier, an air gap may help to reduce heat transfer from the interior portion of the die to the transfer device 140, or vice versa. In this example, the transfer device 140 includes at least one spacer. In particular, this exemplary embodiment of the transfer device 140 includes spacer 142a (which is located at an intermediate portion of transfer device 140), spacer 142b (which is located at an intermediate portion of transfer device 140), and spacer 142c (which is located at an exit end portion of the transfer device 140). A spacer may have any configuration suitable to displace an adjacent side portion of the transfer device 140 from the interior portion of the die. For example, a spacer may be a flange, a rim, a rib, a leg, a spoke, or any other similar or suitable structure, component, or projection for creating the aforementioned displacement. In this example, each of spacers 142a, 142b, and 142c are integral to the transfer device 140. In addition, the spacers 142a , 142b, and 142c extend completely around the periphery of the transfer device 140 in this embodiment. However, in other embodiments of the present invention, a spacer may not be integral, or a spacer may not extend completely around the periphery of the transfer device. FIG. 14 illustrates how a spacer or spacers may help to displace a side portion of this exemplary transfer device 140 from an interior portion of the die. For example, side portion 144 is adjacent to spacer 142a and spacer 142b, and side portion 146 is also adjacent to spacer 142a and spacer 142b. Spacers 142a and 142b substantially abut interior portion 154 and interior portion 156. As a result, side portions 144 and 146 do not substantially abut the interior portion 154 or interior portion 156, thereby creating air gap 160 and air gap 162 between spacer 142a and 142b. In this example, air gap 160 and air gap 162 are connected such that the air gap actually extends completely around the periphery of the transfer device 140 for optimum insulation. However, it should be understood that an air gap may not extend completely around the periphery of a transfer device in other embodiments of the present invention.

A transfer device may be displaced from the interior portion of the die in any other suitable way in the present invention. For example, a transfer device may be curved. As a result, certain portions of the transfer device may substantially abut the interior portion of the die while other portions of the transfer device may be displaced from the interior portion of the die. For another example, the entire transfer device may be displaced from (i.e., not abut) the interior portion of the die in the present invention.

Any desired cooling fluid may be used in the present invention. In one exemplary embodiment, the cooling fluid, e.g., gas or liquid, may have a temperature below about 80 degrees Fahrenheit, more preferably below about 68 degrees Fahrenheit, still more preferably below about 32 degrees Fahrenheit, even more preferably below about minus 100 degrees Fahrenheit. On the other hand, the temperature may be above about minus 325 degrees Fahrenheit, more preferably above about minus 300 degrees Fahrenheit, still more preferably above about minus 275 degrees Fahrenheit, even more preferably above about minus 250 degrees Fahrenheit. However, in some embodiments of the present invention, the cooling fluid may be above about 80 degrees Fahrenheit or below about minus 325 degrees Fahrenheit. Examples of the cooling fluid are air and water. Another example of the cooling fluid is gas or vapor that is produced from a cryogenic fluid. For instance, a cryogenic fluid may have a temperature below about minus 250 degrees Fahrenheit. Examples of cryogenic fluids include, but are not limited to, liquid oxygen, liquid nitrogen, liquid neon, liquid hydrogen, liquid helium, and other similar, suitable, or conventional cryogenic fluids.

In addition to the temperature, the velocity of the cooling fluid may also impact its effectiveness. By selecting a suitable velocity and temperature of the cooling fluid, the inventors have discovered that an entire product can be thoroughly cooled just by injecting the cooling fluid into a hollow portion of the product. The velocity of the cooling fluid may be greater than about 10 miles per hour, more preferably greater than about 40 miles per hour, and it may be less than about 100 miles per hour, more preferably less than about 50 miles per hour. However, it should be recognized that the velocity of the cooling fluid may be less than about 10 miles per hour or greater than about 100 miles per hour in some embodiments.

The efficiency and effectiveness of the present invention may be further increased by diverting the flow of the fluid (e.g., a cooling fluid or a fluid that forms a layer or portion of the resulting product) toward the surface of the extruded product as it exits the die. By concentrating a cooling fluid on a surface of the extrudate, the desired amount of cooling may occur more quickly resulting in the use of less cooling fluid as compared to non-diversion methods. Moreover, the increased cooling efficiency enables the use of warmer cooling fluids and a reduction in the velocity of the cooling fluid as compared to non-diversion methods. For example, this embodiment of the present invention may be particularly useful if it is desired to use a cooling fluid that is warmer than about 80 degrees Fahrenheit. However, it should be recognized that, in many embodiments, it may be desirable to use a cooling fluid below about 80 degrees Fahrenheit for optimal cooling efficiency. On the other hand, in the case of a fluid that is used to form a layer or portion of the resulting product, the diversion of the fluid toward a surface of the extruded product as it exits the die may facilitate the formation of the desired end product.

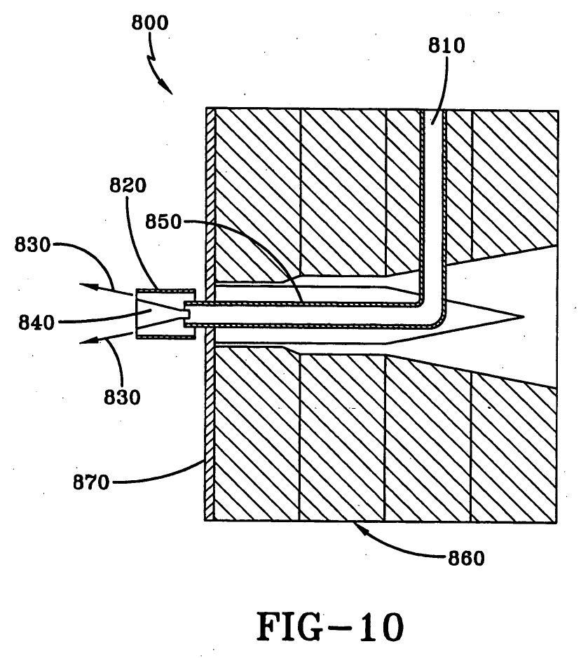

FIG. 10 shows one example of a die that is adapted to divert a fluid toward a surface of an extruded project. The die 800 of this embodiment may include any of the optional or preferred features of the die 700 shown in FIGS. 7 through 9. The fluid may enter the die 800 through a passage 810. A baffle 820 is in fluid communication with the passage 810 such that it receives the fluid. The baffle 820 is adapted to then divert the flow of the fluid such that it is directed to a desired surface of the extrudate. By directing a cooling fluid toward a surface of the extrudate, the baffle 820 may also create a more turbulent flow of the cooling fluid (as compared to a straight line flow that is not directed toward a surface of the extrudate) which further enhances the efficiency of the cooling process. The baffle 820 may be any device or structure that is suitable for diverting the flow of the fluid to the desired location (e.g., an interior or exterior surface of a product). In this particular example, the baffle 820 is adapted to divert the fluid in the direction of arrows 830 toward an interior surface of a hollow portion of the extrudate. For this purpose, the baffle 820 includes an inner conical portion 840 that forces the fluid in the direction of arrows 830.

FIG. 10 shows one example of a design of a baffle 820. It should be recognized that the design of a baffle of the present invention may vary so as to divert the fluid in the desired direction. Of course, the desired direction will vary according to the type of product being extruded and the location of the baffle relative to the extruded product.

The baffle 820 may be placed in fluid communication with the passage 810 in any suitable manner. In the example of FIG. 10, the baffle 820 is secured to an end portion of a conduit 850 that extends through the passage 810. The baffle 820 may be secured to the end portion of the conduit 850 in any desired manner. For example, the baffle 820 may be threaded, i.e., screwed, onto the end portion of the conduit 850. For other examples, the baffle 820 may be secured to the conduit 850 using other mechanical means (e.g., screws, pins, and other types of mechanical fastening devices) and/or adhesives. As previously noted, the conduit 850 may be insulated. The baffle 820 may also be insulated, if desired. The baffle 820 is offset from the heated portion 860 of the die 800 in this particular example. Optionally, there may be an insulated layer 870 on an exit end of the die 800. The insulated layer 870 may be useful to prevent a cooling fluid from cooling the heated portion 860 of the die 800.

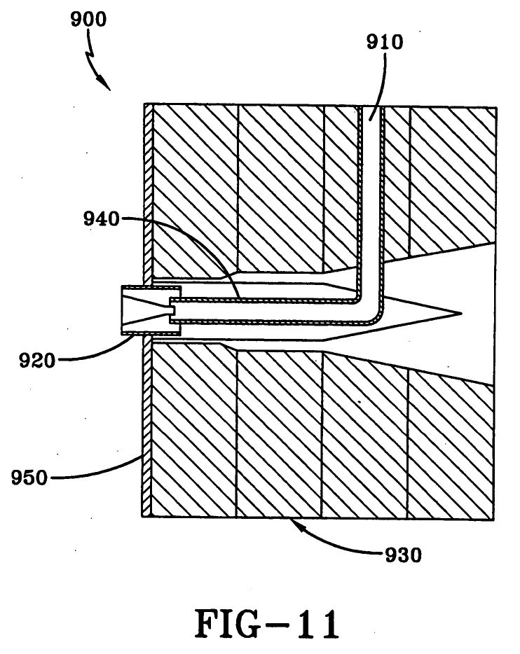

FIG. 11 shows another example of a die which may include any of the optional or preferred features of the other embodiments of the present invention. In this embodiment, the die 900 includes a passage 910 that is in fluid communication with the baffle 920. The baffle 920 is not offset from the heated portion 930 of the die 900 in this example. In order to limit undesired heat transfer from or to the heated portion 930, it may be preferred to use an insulated baffle 920 or otherwise provide a layer of insulation between the baffle 920 and the heated portion 930. As in the previous example, the baffle 920 may be connected to a conduit 940 that lines that passage 910. It should also be recognized that the baffle 920 may be placed in fluid communication with the passage 910 in any other suitable manner. For example, the baffle 920 may have a threaded connection with the heated portion 930. In other examples, the baffle 920 may be connected to the heated portion 930 using other mechanical means (e.g., screws, pins, and other types of mechanical fastening devices) and/or adhesives. As in the previous example, an exit end of the die 900 may include a layer of insulation 950.

The inventors have also made the surprising and significant discovery that the efficiency and efficacy of the manufacturing process may be improved by placing a liquid cryogenic fluid in direct contact with the material to be cooled. As a result, the rate of output may be increased, thereby decreasing the unit cost of the manufactured product. In addition, the inventors have discovered that the more rapid cooling providing by direct contact with a liquid cryogenic fluid may improve the structural characteristics of the manufactured product, especially in the case of foam products. In particular, the rapid removal of the heat may help to maintain the desired foam structure.

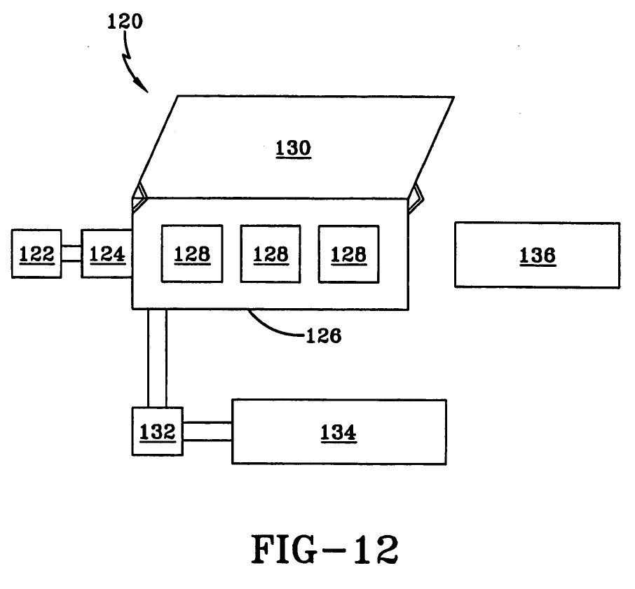

FIG. 12 shows one example of a system that enables direct contact of the material with the liquid cryogenic fluid. System 120 may include a die 122 which is adapted to receive material from a piece of processing equipment, e.g., an extruder. Optionally, a sizer 124 may be in fluid communication with the die 122. One example of a sizer 124 is a vacuum sizer. After the material exits the die 122 and, optionally, sizer 124, the material enters a bath 126 of liquid cryogenic fluid. In the bath 126, the material comes into direct contact with the liquid cryogenic fluid. The duration of the contact may vary according to the particular material, manufacturing process, and degree of cooling that is desired. Nevertheless, it should be recognized that just a brief period of contact (e.g., mere seconds) may provide a significant of degree of heat removal. Depending on the material, overexposure to the liquid cryogenic fluid may eventually have a negative impact on the manufactured product.

The features and physical dimensions of the bath 126 may be selected taking into consideration the minimum length of material needed for a specific application, the line speed, the desired amount of heat removal, and other factors relevant to the safety, maintenance, and performance of the system 120. In one exemplary embodiment, the bath 126 may include at least one sizing component (i.e., sizer or sizing box) 128. A sizing component 128 may be partially or totally submersed in the liquid cryogenic fluid during operation of the system 120. The bath 126 may also be equipped with suitable safety and maintenance features. For example, the bath 126 may have a cover 130 to facilitate maintenance of the bath 126. Additionally, the bath 126 may be dual-walled and insulated, and the bath 126 may include a suitable exhaust system.

The bath 126 may include a level of liquid cryogenic fluid sufficient to partially or totally submerse the material to be cooled. For instance, the bath 126 may include a level of liquid cryogenic fluid sufficient to directly contact one portion of the material to be cooled while another portion does not come into contact with the liquid cryogenic fluid. Moreover, it should be recognized that the liquid cryogenic fluid may be transferred into and out of the bath 126 based on the operational status of the system 120. For example, the system 120 may also include a pump 132 and a holding tank 134. The pump 132 may transfer the liquid cryogenic fluid to the bath 126 from the tank 134 approximately when the particular manufacturing process (e.g., extrusion) is initiated or at any other suitable time such that there is a desired amount of liquid cryogenic fluid in the bath 126. Furthermore, the pump 132 may transfer the liquid cryogenic fluid back to the tank 134 after the manufacturing process (e.g., extrusion) is complete or at any other suitable time. The tank 134 may be equipped with any suitable safety and maintenance features including, but not limited to, those included on the bath 126. Additionally, it should be recognized that a suitable safety interlock system may be included to prohibit undesired transfer of the liquid cryogenic fluid between the bath 126 and the tank 134.

At least one additional cooling system 136 may be included subsequent to the bath 126. Examples of a cooling system 136 include, but are not limited to, a water bath, a spray mist, air flow, another cooling system as described herein, or any other conventional or new cooling system. Additionally, it should be noted that a cooling system 136 (or additional manufacturing equipment) may be included prior to the bath 126 without departing from the scope of the present invention.

As mentioned above, many significant advantages may be achieved by placing the material to be cooled in direct contact with liquid cryogenic fluid. In addition to cooling extruded products, the present invention may be used to cool products made by any other methods including, but not limited to, compression molded products and injection molded products. Regardless of the manufacturing method, the output rate may be increased and the unit cost may be decreased due to the dramatic improvement in cooling efficiency. Also, the capital cost of an exemplary system of the present invention may be reduced as compared to conventional gas cooling systems which require some gas velocity. In addition, the increased cooling efficiency may allow shorter manufacturing lines, thereby further reducing the manufacturing cost.

A variety of products may benefit from the present invention. Examples of products that may benefit the present invention include, but are not limited to, fence components, furniture components, cabinet components, storage device components, lawn edging components, flower box components, floor components, baseboards, roof components, wall covering components, siding components, basement floor components, basement wall covering components, interior and exterior decorative house molding components, crown molding components, chair rail components, picture frame components, deck components, railing components, window molding components, window components, window frames, lineals, door components, door frames, door moldings, boards, and other suitable indoor and outdoor items.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A die comprising:
a transfer device adapted to transfer a fluid, said transfer device comprising a spacer and an adjacent portion to said spacer, said spacer and said adjacent portion situated in an interior of said die;
wherein said spacer substantially abuts an interior portion of said die such that said adjacent portion of said transfer device does not substantially abut said interior potion of said die.

2. The die of claim 1 wherein said transfer device is a tube.

3. The die of claim 1 wherein said transfer device has a circular cross section.

4. The die of claim 1 wherein said transfer device is comprised of an insulating material.

5. The die of claim 1 wherein said transfer device is comprised of a ceramic material.

6. The die of claim 1 further comprising:
a flow channel through said die, said flow channel adapted to transfer a material;
wherein said transfer device intersects said flow channel.

7. The die of claim 1 wherein said spacer is at an exit end portion of said transfer device.

8. The die of claim 1 wherein said spacer is at an intermediate portion of said transfer device.

9. The die of claim 1 further comprising:
a second spacer substantially abutting said interior portion of said die;
wherein said adjacent portion is situated between said spacers.

10. A die comprising:
a transfer device adapted to transfer a fluid, said transfer device having a side portion situated in an interior of said die;
wherein said side portion is displaced from an interior portion of said die.

11. The die of claim 10 wherein said transfer device is a tube.

12. The die of claim 10 wherein said transfer device has a circular cross section.

13. The die of claim 10 wherein said transfer device is comprised of an insulating material.

14. The die of claim 10 wherein said transfer device is comprised of a ceramic material.

15. The die of claim 10 further comprising:
a flow channel through said die, said flow channel adapted to transfer a material;
wherein said transfer device intersects said flow channel.

16. A die comprising:
a transfer device adapted to transfer a fluid, said transfer device situated in an interior of said die;
wherein there is an air gap between said transfer device and an interior portion of said die.

17. The die of claim 16 wherein said transfer device is a tube.

18. The die of claim 16 wherein said transfer device has a circular cross section.

19. The die of claim 16 wherein said transfer device is comprised of an insulating material.

20. The die of claim 16 wherein said transfer device is comprised of a ceramic material.

21. The die of claim 16 further comprising:
a flow channel through said die, said flow channel adapted to transfer a material;
wherein said transfer device intersects said flow channel.

22. The die of claim 16 wherein said air gap extends around the entire periphery of said transfer device.

23. The die of claim 16 further comprising:
a first spacer substantially abutting said interior portion of said die; and
a second spacer substantially abutting said interior portion of said die;
wherein said air gap extends between said spacers.
